(19) United States
(12) Patent Application Publication
(10) Pub. No.: US 2008/0222351 A1
(43) Pub. Date: Sep. 11, 2008

(54) HIGH-SPEED OPTICAL CONNECTION BETWEEN CENTRAL PROCESSING UNIT AND REMOTELY LOCATED RANDOM ACCESS MEMORY

(75) Inventors: Jean-Marc Verdiell, Palo Alto, CA (US); Peter Kirkpatrick, San Francisco, CA (US); Marc Epitaux, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Aprius Inc., Sunnyvale, CA (US)

(21) Appl. No.: 11/683,319

(22) Filed: Mar. 7, 2007

(51) Int. Cl. G06F 13/00

(52) U.S. Cl. 711/104

(57) ABSTRACT

A data transmission assembly includes a first connection terminal coupled to a processing unit and a second connection terminal coupled to a random access memory (RAM) resource. The data transmission assembly also includes a first electrical/optical (EO) signal converter and a second EO signal converter. The first EO signal converter is coupled to the first connection terminal and the second EO signal converter is coupled to the second connection terminal. The data transmission assembly also includes an optical signal propagation medium with a first end and a second end. The first end is attached to the first EO signal converter, and the second end is attached to the second EO signal converter. The signal propagation medium carries signals between the first connection terminal and the second connection terminal to support memory accesses performed by the processing unit to access data at memory locations within the RAM resource.

### CROSS-REFERENCES TO RELATED APPLICATIONS

This application is related to co-owned and co-pending U.S. patent application Ser. No. 11/______, attorney docket number 026529-000300US, which is hereby incorporated by reference.

### BACKGROUND OF THE INVENTION

The present invention relates generally to central processing units and in particular to memory access by central processing units.

A typical computer system includes a central processing unit (CPU) for executing operating system and/or application program instructions and for processing data. A system memory comprising a random access memory (RAM), such as a synchronous dynamic random access memory (SDRAM) on dual inline memory modules (DIMMs) or fully buffered DIMMs (FB-DIMMs) is typically included. The system memory stores data and/or program instructions used by the one or more CPUs while executing the operating system and/or application program instructions.

The CPU must typically be located in close physical proximity to the RAM comprising the system memory to enable reads from the RAM and/or writes to the RAM by the CPU to occur as quickly as possible. The farther apart the CPU and the RAM are separated, the farther an electrical signal carrying data between components must travel, thus introducing distortion and noise into the signals carrying reads and/or writes to system memory. Thus, in a typical implementation, the CPU is located on the same printed circuit board (PCB) as sockets for attaching RAM modules and the connection between the CPU and RAM sockets are linked via a short printed-trace connection.

A typical implementation of a CPU and RAM mounted on a PCB and linked by printed trace connections is illustrated in FIG. 1. FIG. 1 depicts a multi-drop bus (MDB) configuration in which all components are connected to a single set of electrical wires. Arbitration is used to determine which component has control over the bus to transmit information at a particular time. Each of the non-transmitting components listens to the data transmitted over the bus in order to determine whether that component is the intended recipient of the data transmission.

System 100 is implemented on a rigid printed circuit board and includes CPU 110, MDB 115, and a set of DIMM sockets 120. The set of DIMM sockets 120 are adapted for coupling RAM modules such as SDRAM to MDB 115. CPU 110 accesses the RAM modules coupled to DIMM sockets 120 via MDB 115. One skilled in the art will recognize that additional components may be included in a typical implementation. However, these components have been omitted as they are not necessary to illustrate the concepts discussed herein.

Printed trace connections like the one illustrated in FIG. 1 require that CPU 110 and the RAM be in close physical proximity to one another. One reason that CPU 110 must be in close proximity to the RAM is to reduce signal distortion. Signal distortion arises due to attenuation in the channel between CPU 110 and the RAM. Signal distortion also arises due to reflection from various discontinuities in the channel, such as connectors used to couple electronic components to the channel. Another reason that CPU 110 must be located in close proximity to the RAM is signal noise. Signal noise accumulates across a channel, thus creating another incentive for minimizing the distance that signals must travel between CPU 110 and the RAM. Yet another limit on the length of a channel is signal latency. Signal latency increases as the length of the channel increases.

System designers face a number of challenges presented by these and other limitations that require that CPUs and RAM to be located in close physical proximity to one another. For example, one problem that system designers must face is excess heat. Electronic components such as CPUs and RAM produce heat as a byproduct. Close proximity of the CPU and RAM modules may cause high thermal density in the system. Excess heat may damage and/or shorten the lifetime of electronic components and lead to unpredictable component performance. Furthermore, electronic components must also compete for scarce space on the PCB. Physical space limitations on the PCB may limit the amount of RAM that may be included in the system, restrict possibilities for efficient layout of components, and/or raise other difficulties in the design of the system.

Alternative implementations of system 100 may include FB-DIMMs instead of DIMMs. FB-DIMM includes an advanced memory buffer (“AMB”) that provides an interface between the memory controller and the memory. A typical DIMM implementation does not include an AMB, and instead includes a parallel data bus where data lines from the memory controller are connected to data lines of each memory module. However, this parallel design may impose limits on the speed and/or memory density of the system, because as the memory width and/or access speed increases, data signal degradation may occur at the interface between the data bus and the memory modules.

FB-DIMM implementations instead include a serial interface between the memory controller and the AMB. The serial interface between the memory controller and the AMB allows memory width to be increased without also requiring a corresponding increase in the pin count of the memory controller, because the memory controller is connected to the AMB via the serial connection and the AMB is connected to the memory modules.

The AMB provides the memory module with an interface for reading data from and writing data to the memory. The AMB buffers memory reads and writes. Buffering enables the AMB to compensate for signal deterioration by retransmitting the signal. Buffering may also enable the memory controller to perform reads and writes in parallel.

Like the multi-drop implementation described in FIG. 1, FB-DIMM implementations also present a number of challenges as to system designers. FB-DIMM implementations may enable higher memory capacity than multi-drop implantations, for example, but higher memory capacity may exacerbate thermal density problems in the system as larger amounts of RAM are placed in close proximity to the CPU and other electronic components that also produce heat as a byproduct. Furthermore, electronic components must also compete for scarce space on the PCB. Therefore, even though FB-DIMM implementations may allow higher memory capacity than DIMM implementations, physical space limitations on the PCB may still limit the amount of RAM that may be included in the system, restrict possibilities for efficient layout of components, and/or raise other difficulties in the design of the system.

### BRIEF SUMMARY OF THE INVENTION

The present invention provides a high-speed optical connection between a central processing unit (CPU) and remotely located random access memory (RAM) resource. The present invention advantageously overcomes the requirement that a CPU and a RAM resource be located in close physical proximity to one another. The present invention uses a high-speed optical connection which enables a CPU and a RAM resource to be located farther apart on the same PCB or to be mounted on separate PCBs.

The present invention also advantageously provides for pooling of memory on the RAM resource. Memory pooling provides numerous advantages, including static or dynamic allocation of memory resources across various processes or CPUs, direct memory transfer between address spaces of different CPUs, and shared coherent memory space for multiple CPUs and processes.

In addition to the advantages provided by memory pooling, the present invention also advantageously alleviates space problems on the PCB by allowing the RAM to be located, for example, on a separate PCB. Accordingly, the present invention also advantageously overcomes the heat density problem by allowing the CPU and RAM to be located farther apart from one another.

In an embodiment of the present invention, a data transmission assembly is provided. The data transmission assembly includes a first connection terminal coupled to a processing unit. The data transmission assembly also includes a second connection terminal coupled to a RAM resource. The data transmission assembly also includes a first electrical/optical (EO) signal converter and a second EO signal converter. The first EO signal converter is coupled to the first connection terminal and the second EO signal converter is coupled to the second connection terminal. The data transmission assembly also includes an optical signal propagation medium. The optical signal propagation medium includes a first end and a second end. The first end of the optical signal propagation medium is attached to the first EO signal converter, and the second end of the optical signal propagation medium is attached to the second EO signal converter. The signal propagation medium is adapted to carry signals between the first connection terminal and the second connection terminal to support memory accesses performed by the processing unit to access data at memory locations within the RAM resource.

Other features and advantages of the invention will be apparent in view of the following detailed description and preferred embodiments.

### BRIEF DESCRIPTION OF THE DRAWINGS

FIG. 1 is a block diagram of a prior art MDB system.

FIG. 2 is a block diagram of a high-speed optical connection between a central processing unit and a remotely located random access memory according to an embodiment of the present invention.

FIG. 3 is a block diagram of a multiple-server system utilizing high speed optical connections, each high speed connection being formed between a central processing unit of a server and a remotely located random access memory resource, according to an embodiment of the present invention.

FIG. 4 is a chart comparing the latencies for a round-trip memory access in different system configurations.

### DETAILED DESCRIPTION OF THE INVENTION

Embodiments of the invention are described here, with reference to the figures. Where elements of the figures are called out with reference numbers, it should be understood that like reference numbers refer to like elements and might or might not be the same instance of the element.

The present invention advantageously provides a system that overcomes the limitations of systems currently known in the art by providing a high-speed connection between a CPU and a remotely located random access memory (RAM). The high-speed optical connection allows for a CPU and a RAM resource to be located farther apart on a single printed circuit board (PCB) than would be possible with typical electrical connections, such as printed trace connection. Furthermore, in some embodiments the CPU and RAM are located on separate PCBs. Thus, the amount of system memory that may be made available to a CPU is not limited by the amount of physical space available on the PCB upon which the CPU mounted.

Using a remote RAM resource allows multiple CPUs and/or processes to share the same remote RAM resource. As a result, the present invention advantageously provides for memory pooling on the remote RAM resource. Memory pooling provides numerous advantages, including static or dynamic allocation of memory resources across various processes or CPUs, direct memory transfer between address spaces of different CPUs, and shared coherent memory space for multiple CPUs and processes.

The static allocation of memory provided by embodiments of the present invention facilitates maintenance of memory resources for collections of processors. For example, a technician might easily add or remove memory and/or reconfigure memory capacity for a collection of processor all at once.

The dynamic allocation of memory across various processes and CPUs provided by embodiments of the present invention facilitates more efficient use of memory resources. For example, in a typical system, each CPU is provided a finite amount of RAM mounted on the PCB with the CPU. The CPU is limited to the amount of RAM provided on the PCB, and RAM provided may be more or less RAM than is required by the CPU at a particular time. If the RAM is not being fully utilized by the CPU, other CPUs in the system are not able to make use of the RAM.

The present invention enables CPUs to access a large pool of RAM on a remote RAM resource. Each CPU may access the shared pool of RAM either in place of or in conjunction with RAM physically located on the PCB. Each CPU and/or individual process running on each CPU may be allocated memory from the shared pool of memory on the remote RAM resource. If a CPU and/or process no longer needs a segment of memory, the CPU or process may release the memory back to the memory pool so that other CPUs and/or processes may use the memory. Furthermore, if a CPU and/or process requires additional memory, the CPU and/or process can receive additional memory allocations as needed from the memory pool, if sufficient free memory exists in the memory pool.

Another advantage of the present invention is direct memory transfer between address spaces of different CPUs. Because multiple CPUs share a remote RAM resource, direct memory transfer may be used to copy data from the address space of one CPU to the address space of another CPU. Thus, a direct memory transfer may advantageously be used to copy data from the address space of one CPU to the address space of another CPU without subjecting either CPU to the overhead of performing the copying of the data from the source address space to the destination address space.

Yet another advantage of the present invention is that it provides a shared coherent memory space for multiple CPUs and processes. For example, if a first CPU of the plurality of CPUs sharing the pooled memory on the remote RAM resource updates a data item in the shared memory, a second CPU of the plurality of CPUs sharing the memory pool will have access to the updated data, without needing to determine if the data has been updated by another CPU. In contrast, in a typical multi-CPU system, each CPU referencing a particular data item may maintain a copy of the data in local memory, and each CPU may make updates the CPU's local copy of the data. Therefore, care needs to be taken to ensure that each CPU referencing the data has the latest copy in local memory. The present invention advantageously avoids this synchronization problem by providing a shared coherent memory space for the CPUs where each of the CPUs can access the same instance of the data item in the memory pool.

Furthermore, the high-speed optical connection also alleviates the problem of excess heat damaging and/or shortening the lifespan of electronic components. The present invention enables the CPU and RAM to be physically located further from one another within a computer system. CPUs and RAM are two primary sources of excess heat in a computer system. Physically separating sources of excess heat in a system helps prevent areas of higher thermal density in the system and facilitates maintaining an ideal operating temperature throughout the system.

FIG. 2 is a block diagram of a high-speed optical connection between a central processing unit and a remote random access memory according to an embodiment of the present invention. System 200 may be implemented in any electronic device that includes a CPU and a system memory, such as computer servers, desktop computers, laptop computers, networking devices, and/or consumer electronic devices.

System 200 includes CPU 210, connection terminal 230, electrical-optical (EO) converter 235, optical connector 237, optical signal propagation medium 245, optical connector 247, EO signal converter 250, connection terminal 255, and RAM resource 220. In some embodiments, CPU 210 is mounted on the same printed circuit board (PCB) as RAM resource 220. In other embodiments, CPU 210 and RAM resource 220 are located on different PCBs.

CPU 210 writes data to and reads data from RAM resource 220 over the high speed optical connection. Here, CPU 210 includes a memory controller 205. Memory controller 205 manages the flow of data to and from RAM module 220. In some embodiments, memory controller 205 is implemented as a separate chip coupled to CPU 210 via bus or other communication path. In some embodiments connection terminal 230 is coupled to memory controller 205 via an electrical interface (metallic and/or dielectric). In alternative embodiments, connection terminal 230 may be coupled to the PCB upon which CPU 210 is coupled and connection terminal 230 communicates with memory controller 205 via a bus or other communication path. In yet other embodiments, connection terminal 230 may be coupled to a standard memory socket, such as a DIMM or FB-DIMM socket located on the same PCB as CPU 210 where the socket is coupled.

As described above, the present invention may, for example, be coupled to standard memory sockets, such as DIMM or FB-DIMM sockets found in a variety of typical computer systems. The present invention is thus able to be used to expand the amount of system memory available for a variety of typical computer systems comprising off-the-shelf parts without the need for specialized hardware and/or connectors included on the printed circuit boards of the computer systems.

Connection terminal 230 is coupled to EO signal converter 235. In an embodiment, EO signal converter 235 is coupled to terminal 230 by being built into terminal 230. In some embodiments, connection terminal 230 may be directly coupled to the PCB upon which CPU 210 is mounted, such as by being soldered directly to the PCB, and connection terminal 230 communicates with CPU 210 via a bus or other communication path. In other embodiments, connection terminal 230 may be adapted to couple to a conventional port on the PCB. For example, EO signal converter 235 may be adapted to plug into a standard memory socket, such as a DIMM or FB-DIMM socket coupled to the PCB upon which CPU 210 is mounted.

EO signal converter 235 is a transceiver adapted to convert electrical signals received from CPU 210 to optical signals which are transmitted to EO signal converter 250 via optical signal propagation medium 245. EO signal converter 235 is also adapted to receive optical data signals from EO signal converter 255 and converts the optical data signals to electrical data signals which are transmitted to CPU 210 via connection terminal 230. Optical connector 245 couples EO signal converter 235 to the end of optical signal propagation medium 245 proximate to CPU 210.

Optical data signals, such as those used by the present invention, advantageously permit digital data transmission over longer distances and at higher data rates than electronic communications. Optical data signals also provide improved signal integrity and lower distortion over electrical data signals. Furthermore, the use of optical data signals instead of electrical data signals results in lower signal attenuation, the absence of electrical signal reflections, and increased immunity to interference by radiated noise (electrical signals are more susceptible to electromagnetic noise emitted, for example, by nearby electrical devices). Furthermore, as the length of an electrical connection increases, problems such as signal attenuation, electrical signal reflections, and noise interference also increase, which imposes limits on the length of electrical links. The optical links provided by the present invention overcome at least these problems by transmitting optical signals over an optical signal propagation medium. As a result, RAM resource 220 may be physically located farther from CPU 210, including, in some embodiments, being mounted on a separate PCB than CPU 210, while advantageously avoiding the problems inherent to electrical links.

Optical signal propagation medium 245 comprises an optical waveguide, a physical structure that guides electromagnetic waves in the optical spectrum. Various types of optical waveguides exist and are classified by a number of characteristics including waveguide geometry (planar, strip, fiber), mode structure (single or multi-mode, refractive index distribution (step or gradient index) and material composition (e.g. glass, polymer, semiconductor). In a preferred embodiment, optical signal propagation medium 245 comprises an optical fiber cable. In another preferred embodiment, optical signal propagation medium 245 comprises a parallel optical cable, such as a 12-fiber ribbon. Various widths of parallel optical cable may be used in different embodiments. In an alternative embodiment, optical signal propagation medium 245 comprises an optical backplane. In some embodiments, optical signal propagation medium 245 may comprise parallel channels. Furthermore, in some embodiments, optical signal propagation medium 245 includes a channel reserved for out-of-band signals, such as clock signals, system control messages, user messages and/or data or information not part of the data being stored to or read from the RAM resource.

Optical connector 247 couples EO signal converter 250 to the end of optical signal propagation medium 245 proximate to RAM resource 220. EO signal converter 250 transmits optical data signals to and receives optical data signals from EO signal converter 235 via optical signal propagation medium 245. EO signal converter 250 is coupled to connection terminal 255. In one embodiment, EO signal converter 250 is coupled to terminal 255 by being built into terminal 255. EO signal converter 250 receives electrical data signals from RAM resource 220 and converts the electrical data signals to optical data signals which are transmitted to EO signal converter 235 via optical signal propagation medium 245. EO signal converter 250 also receives optical data signals from EO signal converter 235 and converts the optical data signals to electric data signals which are transmitted to RAM resource 220 via connection terminal 255.

EO signal converter 235 and EO signal converter 250 are electrical-optical transceivers that may be implemented in different ways, including that disclosed in concurrently filed U.S. patent application Ser. No. 11/______, attorney docket number 026529-000300US.

Connection terminal 255 is coupled to RAM resource 220 via a bus or other communication path. In some embodiments, connection terminal 255 is coupled to the PCB upon which RAM 220 is mounted and connection terminal 255 communicates with RAM 220 via a bus or other communication path. In other embodiments, connection terminal 255 may be adapted to couple to a standard memory socket, such as a DIMM or FB-DIMM socket coupled to the PCB upon which RAM 220 is coupled.

System 200 depicted in FIG. 2 advantageously provides a serial high-speed optical connection between memory controller 205 and the RAM resource 220. The serial connection enables the width of the memory bus to be reduced. Unlike parallel bus architectures, serial connections do not require a corresponding increase in the number of pins of the memory controller as the width of the memory increases. As described above, FB-DIMM also provides a serial interface between the memory controller and RAM resource 220. However, the present invention advantageously uses optical data signals unlike FB-DIMM which uses only electrical data signals.

In a preferred embodiment, optical signal propagation medium 245 comprises a parallel optical medium, such as 12-fiber ribbon. Accordingly, EO signal converter 235 and EO signal converter 250 are adapted to couple to a parallel optical medium and thus provide multiple optical inputs and/or outputs to be coupled to optical signal propagation medium 245. Also, the reduced-width bus provided by the present invention is carried over the parallel optical medium in embodiments where optical signal propagation medium 245 comprises a parallel optical medium.

Embodiments of the present invention are also adapted to carry sideband signals across an optical channel. The use of sideband signals enables an optical channel to be used to carry signals in addition to data signals, and thus, enabling optical channels to be used for multiple purposes without interfering with data transmissions across the channels. For example, sideband signals such as for clocking or system control may be included in the sideband signal.

System 200 also advantageously enables a CPU and a RAM resource to be located further apart in an electronic device by linking the RAM and CPU with a high-speed optical connection. As described above, CPUs and RAM resources may produce a significant amount of heat as they operate. Excess heat can damage delicate electronic components of a computer system, shortening life of the components and decreasing reliability of the electronic device. The system illustrated in FIG. 2 provides for a greater physical separation between CPU 210 and RAM resource 220. Therefore, the heat produced by these components could be spread out over a greater area, lessening the likelihood that the components may be damaged and making it easier to cool the system. Furthermore, as electronic systems have become increasingly more complex, components have to compete for space on the PCB. Physical space limitations on the PCB may require that less than the desired system memory capacity be included since a CPU and RAM needed to be located in close proximity to one another on the same PCB. By utilizing high-speed optical links, RAM can be located separately from a CPU. Thus, the amount of system memory is no longer constrained by physical space limitations on the PCB upon which the CPU is located.

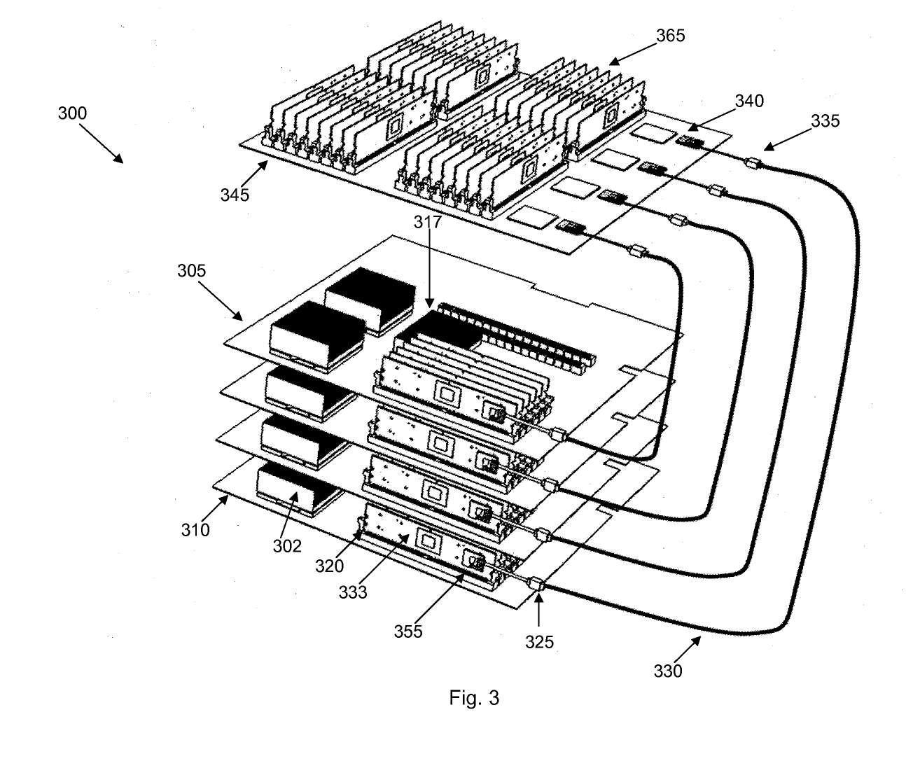

In other embodiments of the present invention, high-speed optical connections are used to connect multiple servers to a shared remote memory resource. FIG. 3 is a block diagram of a multiple-server system 300 utilizing high speed optical connections, each high speed connection being formed between a central processing unit of a server and a remotely located random access memory resource, according to an embodiment of the present invention. The illustrated embodiment of the present invention is advantageously adapted to enable a plurality of servers to share a RAM memory resource accessed via high-speed optical connections.

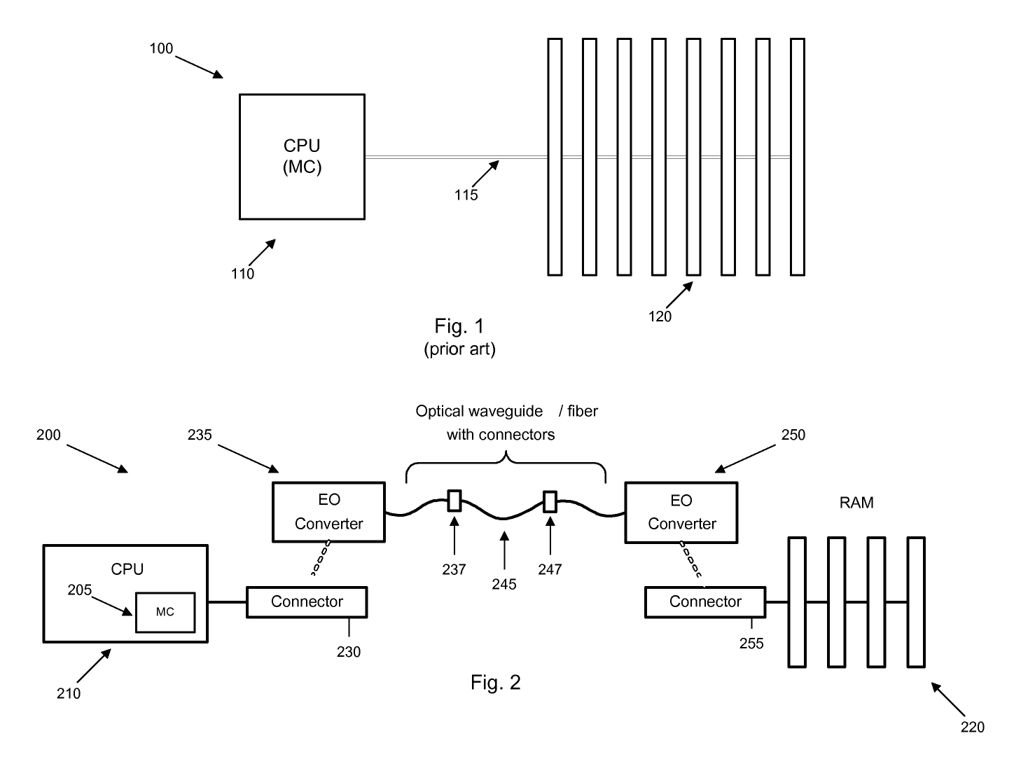

In a typical system, such as those described in FIG. 1, a CPU only has access to a limited amount of RAM due to constraints such as physical space on the PCB, power, and excess heat generated by components. These and other constraints prevent additional RAM from being included on the PCB. Furthermore, in typical systems, communications between a CPU and RAM occurs over electrical data paths, the length of which are limited by electrical signal integrity, noise coupling, and the speed of propagation across the electrical medium. If an electrical data path between a CPU and RAM is too long, too much latency will be introduced in reads from and writes to RAM.

The present invention overcomes these and other limitations by providing a remotely located RAM resource accessible by the CPU via a high-speed optical connection. The high speed optical connection is adapted to provide significantly better signal integrity, high immunity to interference, and higher propagation speeds than those provided via electrical connections, thus overcoming the latency problem introduced by electrical connections and allowing the RAM resource to be located farther from the CPU. Thus, the CPU will be able to access a much larger system memory since system memory size is not constrained by physical constraints imposed by the PCB.

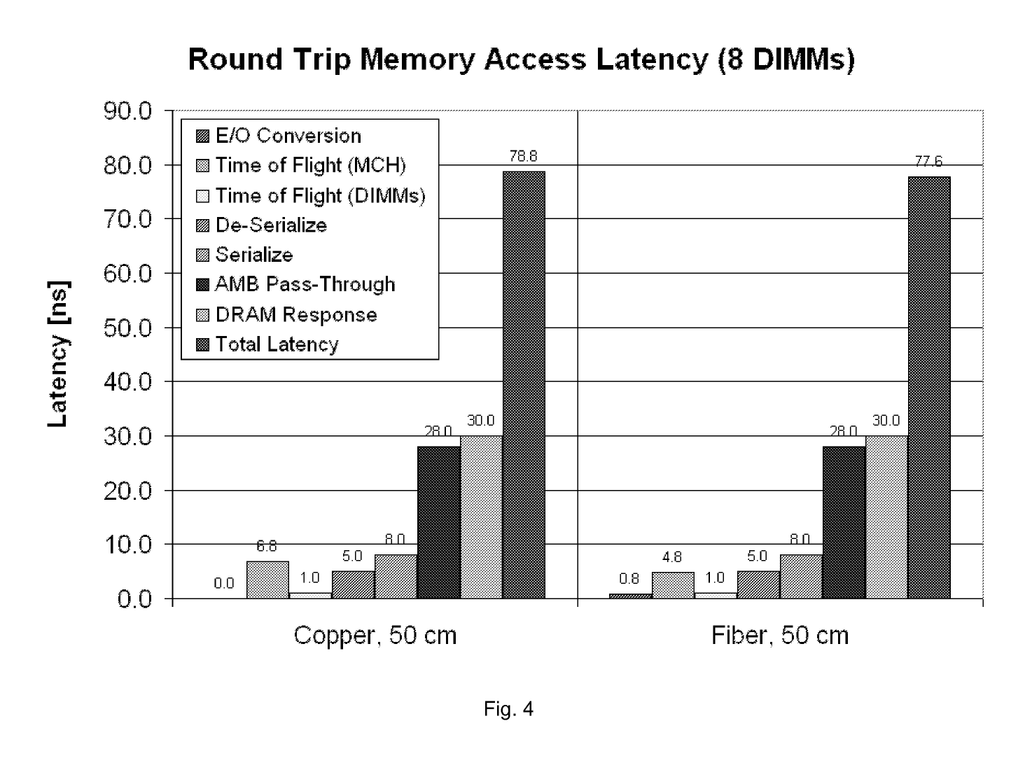

FIG. 4 is a chart comparing the latencies for a round-trip memory access in different system configurations according to one embodiment. FIG. 4 provides an example of the decreases in latency that might be realized for round-trip memory accesses by substituting an optical link according to embodiments of the present invention for copper links. The set of values on the left (labeled “Copper, 50 cm”) represent the latencies due to various system components when a copper cable link is used. The set of values on the right (labeled “Fiber, 50 cm”) represent the latencies due to various system components when the link is formed using an optical link such as those of the various embodiments described herein. The higher speed of propagation of optical signals results in a lower round-trip memory access latency.

Referring now back to the multiple-server system depicted in FIG. 3, multiple-server system 300 comprises a plurality of computer servers 305, plurality of memory sockets 320, plurality of DIMMs 333, plurality of EO signal converters 355, plurality of optical connectors 325, plurality of optical signal propagation mediums 330, plurality of optical connectors 335, plurality of EO signal converters 340, and shared RAM resource 315 mounted on PCB 345.

As shown, computer servers 305 are coupled to shared RAM resource 315. Each of the plurality of computer servers 305 is a conventional computer server mounted on a printed circuit board (PCB) 31 0. For example, in some embodiments, the plurality of servers 305 is rack-mounted servers.

Computer server 305 includes a set of at least one CPUs 302, a data bus or other communication pathways between components of the server and memory socket 320. In an embodiment, memory socket 320 is a standard memory socket, such as a DIMM or FB-DIMM socket mounted on PCB 310. Each CPU 302 also includes a memory controller 317. Memory controller 317 manages the flow of data to and from shared RAM resource 315. In some embodiments, memory controller 317 is implemented as a separate chip, such as a conventional memory controller hub chip, coupled to CPU 302 via bus or other communication path. Furthermore, in other embodiments, computer server 305 includes more than one CPU 302, and memory controller 317 manages memory access for more than one CPU 302. CPU 302 writes data to and reads data from shared RAM resource 315 over a high speed optical connection comprising EO signal converter 355 mounted on a DIMM-style card 333, optical connector 325, optical signal propagation medium 330, optical connector 335, and EO signal converter 340.

EO signal converter 355 is mounted on DIMM-style card 333 coupled to standard memory socket 320. In some embodiments, EO signal converter is 355 is adapted to plug into a standard memory socket such as a DIMM or FB-DIMM socket. For example, in the present embodiment, EO signal converter 355 is mounted on a DIMM-style card adapted for insertion into a DIMM socket. However, in alternative embodiments, EO signal converter 355 may be soldered directly to PCB 310, and communicate with memory controller 317 via a bus or data path. In yet other embodiments, EO signal converter 355 may be directly coupled to memory controller 317 via an electrical interface (metallic and/or dielectric interface).

EO signal converter 355 is adapted to convert electrical signals received from CPU 302 to optical signals and the optical signals are transmitted to EO signal converter 340 via optical signal propagation medium 330. EO signal converter 355 is also adapted to receive optical data signals from EO signal converter 340 via optical signal propagation medium 330. EO signal converter 355 converts the optical data signals received from EO signal converter 340 to electrical data signals. The converted electrical signals are then transmitted to CPU 302 via memory socket 320. In alternative embodiments where EO signal converter 355 is soldered directly to PCB 310, EO signal converter 340 communicates with CPU 302 via a bus or data path.

Optical signal propagation medium 330 comprises an optical waveguide, such as those described above. Optical signal propagation medium 330 provides a conduit for high-speed optical communications between computer server 305 and shared RAM resource 315. In a preferred embodiment, optical signal propagation medium 330 comprises an optical fiber. Optical signal propagation medium 330 is coupled to EO signal converter 355 via optical connector 335 and EO signal converter 340 via optical connector 325. Optical signal propagation medium 330 provides a conduit for bidirectional optical data signal transmissions between EO signal converter 340 and EO signal converter 355. In embodiments where optical signal propagation medium 330 comprises an optical fiber, optical connector 325 and optical connector 335 may comprise an optical fiber connector. In a preferred embodiment, optical signal propagation medium 330 comprises an optical ribbon cable, such as a 12-fiber ribbon. Accordingly, EO signal converter 340 and EO signal converter 355 are adapted to couple to a parallel optical medium, and thus, provide multiple optical inputs and/or outputs to be coupled to optical signal propagation medium 330.

EO signal converter 340, like EO signal converter 355, is a transceiver adapted to convert electrical to optical data signals and vice versa. EO signal converter 340 is coupled to optical signal propagation medium 330 via optical connector 335 and to PCB 345. EO signal converter 340 is adapted to receive optical signals from EO signal converter 355 via optical signal propagation medium 330. EO signal converter 340 converts the optical data signal to an electrical signal and transmits the signal to shared RAM resource 315. EO signal converter 340 is also adapted to receive electrical signals from shared RAM resource 315 and convert the electrical signals to optical signal to transmit to EO signal converter 355 via optical signal propagation medium 330.

EO signal converter 340 and EO signal converter 355 are electrical-optical transceivers that may be implemented in different ways, including that disclosed in concurrently filed U.S. patent application Ser. No. 11/______, attorney docket number 026529-000300US. In a preferred embodiment, EO signal converters 340 and 355 provide parallel data channels in both directions. Furthermore, EO signal converters 340 and 355 also include a sideband channel for relaying signals such as clock signals, and system control and management messages, in addition to a plurality of in-band data channels.

EO signal converter 340 may be directly connected to PCB 345 of shared RAM resource 315, such as being soldered directly to PCB 345. In alternative embodiments, EO signal converter 340 may be adapted to plug into a conventional port included on PCB 345, such as a DIMM or FB-DIMM port. In yet other embodiments, EO signal converter 340 may be mounted on a card adapted to plug into standard memory socket, such as a DIMM-style card.

Shared RAM resource 315 includes a PCB 345 and a plurality of RAM modules 365. Plurality of RAM modules may include any conventional random access memory, such as a synchronous dynamic random access memory (SDRAM) or dynamic random access memory (DRAM). Plurality of RAM modules 315 may be connected via data bus or other communication paths. Plurality of RAM modules 315 is coupled to plurality of connection terminals 340 via bus or data paths to enable electrical data signals to pass between the plurality of connection terminals 340 and plurality of RAM modules 315. Memory controllers 317 of the plurality of servers 305 control read/write access to plurality of RAM modules 365 of share RAM resource 315.

The embodiment described in FIG. 3 advantageously provides plurality of computer servers 305 with and remote RAM resource 315 via a high-speed optical connection. This embodiment enables multiple computer servers or other electronic devices to share a large pool of random access memory. In some embodiments, the configuration described in FIG. 3 enables space on the printed circuit boards of the servers that would otherwise be occupied by system memory (RAM) to be utilized for other components. In alternative embodiments, the overall size of a PCB upon which the CPU is mounted may be decreased as at least a portion of the system memory is located off-board. Moreover, the overall amount of system memory available to each individual server is not limited by the amount of physical space available on the PCB upon which the CPUs of the servers are mounted. Each server has access to remote RAM resource 315. Furthermore, as describe above, memory pooling provides numerous other advantages, including static or dynamic allocation of memory resources across various processes or CPUs, direct memory transfer between address spaces of different CPUs, and shared coherent memory space for multiple CPUs and processes.

While the embodiment described in FIG. 3 makes reference to plurality of computer servers 305, the present invention may be utilized to provide a high-speed optical connection to other computer resources that include a central processing unit and could advantageously utilize a high-speed connection. Furthermore, in some embodiments, plurality of computer servers 305 (or other electronic devices according to alternative embodiments of the present invention) may include onboard system memory that may be utilized in conjunction with or instead of remote RAM resource 315.

One skilled in the art will recognize that the teachings of the figures and this disclosure as depicted as examples of implementations of the present invention, and that many other implementations are possible without departing from the present invention. For example, the various embodiments discussed herein refer to single CPU systems. One skilled in the art will recognize that the various embodiments of the present invention may be adapted for use with multi-core and multi-processors systems as well.

The embodiments described above provide a high-speed optical connection for linking one or more CPUs to a RAM resource. In some embodiments, a plurality of high-speed optical connections may be used to link a plurality of computer servers to a shared RAM resource.

While the embodiments described above may make reference to specific hardware and software components, those skilled in the art will appreciate that different combinations of hardware and/or software components may also be used and that particular operations described as being implemented in hardware might also be implemented in software or vice versa. For instance, the invention may be implemented with multiple shared RAM resources shared by a single and/or multiple computer servers.

Computer programs incorporating various features of the present invention may be encoded on various computer readable media for storage and/or transmission; suitable media include magnetic disk or tape, optical storage media such as compact disk (CD) or DVD (digital versatile disk), flash memory, and the like. Such programs may also be encoded and transmitted using carrier signals adapted for transmission via wired, optical, and/or wireless networks conforming to a variety of protocols, including the Internet. Computer readable media encoded with the program code may be packaged with a compatible device or provided separately from other devices (e.g., via Internet download).

Thus, although the invention has been described with respect to specific embodiments, it will be appreciated that the invention is intended to cover all modifications and equivalents within the scope of the following claims.

What is claimed is:

1. A data transmission assembly comprising:
a first connection terminal coupled to a processing unit;
a second connection terminal coupled to a random access memory (RAM) resource;
a first electrical/optical (EO) signal converter coupled to the first connection terminal;
a second electrical/optical (EO) signal converter coupled to the second connection terminal; and
an optical signal propagation medium comprising a first end and a second end, the first end of the signal propagation medium being attached to the first EO signal converter and the second end of the signal propagation medium being attached to the second EO signal converter;
wherein the signal propagation medium is adapted to carry signals between the first connection terminal and the second connection terminal to support memory accesses performed by the processing unit to access data at memory locations within the RAM resource.

2. The data transmission assembly of claim 1 wherein the processing unit is mounted on one printed circuit board and the RAM resource is mounted on a separate printed circuit board.

3. The data transmission assembly of claim 1 wherein the data transmission assembly supports multi-processor connection to a shared memory unit, the multi-processor connection using multiple ones of the data transmission assembly to separately connect each one of a plurality of processing units to the shared memory unit.

4. The data transmission assembly of claim 1 wherein the first connection terminal is adapted to being indirectly coupled to the processing unit via a memory controller, wherein the first connection terminal is connected with the memory controller, and the memory controller is connected with the processing unit.

5. The data transmission assembly of claim 1 wherein the first connection terminal is adapted to being coupled to the processing resource by using a standard connector.

6. The data transmission assembly of claim 5 wherein the standard connector comprises a dual in-line memory module (DIMM) socket.

7. The data transmission assembly of claim 6 wherein the DIMM socket is a fully buffered dual in-line memory module (FB-DIMM) socket.

8. The data transmission assembly of claim 1 wherein the processing unit is installed on a first printed circuit board, and the first EO signal converter is mounted on a dual in-line memory module (DIMM) style card adapted for insertion into a DIMM socket mounted on the first printed circuit board.

9. The data transmission assembly of claim 1 wherein the signal propagation medium comprises an optical fiber cable.

10. The data transmission assembly of claim 1 wherein the signal propagation medium comprises an optical backplane.

11. The data transmission assembly of claim 1 wherein the RAM resource is installed on a second printed circuit board, and the second connection terminal is mounted on the second printed circuit board.

12. The data transmission assembly of claim 1 wherein the RAM resource serves as system memory for the processor unit.

13. The data transmission assembly of claim 1 wherein the RAM resource serves as cache for the processor unit.

14. The data transmission assembly of claim 1 wherein the RAM resource serves as back up memory for a primary memory resource separately interfaced to the processing unit.

15. The data transmission assembly of claim 1 wherein the processing unit is a central processing unit (CPU).

16. The data transmission assembly of claim 1 wherein the RAM resource comprises dynamic random access memory (DRAM).

17. The data transmission assembly of claim 1 wherein the optical signal propagation medium comprises parallel channels.

18. The data transmission assembly of claim 17 wherein the optical signal propagation medium includes a channel reserved for out-of-band signals.

19. A multi-server computer system comprising:
a plurality of computer servers; and
a shared random access memory (RAM) resource;
wherein each of the plurality of computer servers are coupled to the shared RAM resource via a data transmission assembly, the data transmission assembly includes:
a first connection terminal coupled to a processing unit of one of the plurality of computer servers;
a second connection terminal coupled to the shared RAM resource;
a first electrical/optical (EO) signal converter coupled to the first connection terminal;
a second electrical/optical (EO) signal converter coupled to the second connection terminal; and
an optical signal propagation medium comprising a first end and a second end, the first end of the signal propagation medium being attached to the first EO signal converter and the second end of the signal propagation medium being attached to the second EO signal converter;
wherein the signal propagation medium is adapted to carry signals between the first connection terminal and the second connection terminal to support memory accesses performed by the processing unit to access data at memory locations within the shared RAM resource.

20. The multi-server computer system of claim 19 wherein the first connection terminal is adapted to being coupled to the processing resource by using a standard connector.

21. The multi-server computer system of claim 20 wherein the standard connector comprises a dual in-line memory module (DIMM) socket.

22. The multi-server computer system of claim 20 wherein the DIMM socket is a fully buffered dual in-line memory module (FB-DIMM) socket.
